(19) United States
(12) Patent Application Publication
(10) Pub. No.: US 2011/0042580 A1
(43) Pub. Date: Feb. 24, 2011

(54) FLUORESCENCE QUANTIFICATION AND IMAGE ACQUISITION IN HIGHLY TURBID MEDIA

(75) Inventors: Brian Wilson, Toronto (CA); Arjen Bogaards, Toronto (CA)

Correspondence Address: BERESKIN AND PARR LLP/S.E.N.C.R.L., s.r.l., 40 KING STREET WEST, BOX 401, TORONTO, ON, M5H 3Y2, CA

(73) Assignee: UNIVERSITY HEALTH NETWORK, Toronto, ON (CA)

(21) Appl. No.: 12/440,327

(22) PCT Filed: Sep. 6, 2007
(86) PCT No.: PCT/CA2007/001581

§ 371 Date: Jan. 4, 2010

Related U.S. Application Data
(60) Provisional application No. 60/842,387, filed on Sep. 6, 2006.

(51) Int. Cl. G01J 1/58

(52) U.S. Cl. 250/458.1; 250/200

(57) ABSTRACT

Various embodiments of methods and systems are described herein for the acquisition and quantification of fluorescence or luminescence signals from a region of interest of an object. The quantification of the acquired signals includes performing at least one ratiometric operation to correct these signals for artifacts due to various factors.

### FIELD

Various embodiments of methods and devices are described herein that relate to fluorescence imaging, which can be used in various applications including medical imaging.

### BACKGROUND

Administration of a targeted fluorescent marker is one approach that can enhance a physician's ability to visualize early cancers and other medical conditions. After administration of the fluorescent marker, the tissue can be illuminated with light of an appropriate wavelength to excite the fluorescent marker while the resulting fluorescence is detected using a sensitive light detector.

The diagnostic accuracy of this approach has varied widely mainly due to reliance on more traditional, passive targeting strategies. These strategies attempted to exploit the differences in vasculature or pharmacokinetics between tumors and normal tissues. However, non-specific uptake of more traditional fluorescent markers resulted in low fluorescence contrast between tumors and surrounding normal tissue.

Recent advances in genomics, proteomics and nanotechnology have enabled the engineering of nanoparticles that comprise a targeting moiety (such as antibodies, antibody fragments or peptides) conjugated to a marker ligant. The advent of these new particles suggests the possibility of active targeting of a region of interest in the body. Imaging of these particles can be used for early detection of cancer as well as for yielding functional information, on a molecular level, about the invasiveness, progression and treatment response of the disease. This information, directly available to the clinician during ‘molecular diagnostic screening’ or ‘molecular image-guided surgery’, has the potential to improve clinical decision-making and could ultimately improve diagnostic accuracy and outcome.

Both diagnostic screening and image-guided surgery involve high throughput, high-resolution images of the tissue surface, with real-time display of at least approximately 30 frames/sec being preferred. However, MRI, SPECT, PET, optical fluorescence tomography, hyper-spectral fluorescence imaging and bioluminescence imaging do not currently offer such high frame rates. By contrast, 2-Dimensional (2D) ultrasound and 2D optical fluorescence imaging do offer high throughput imaging. Ultrasound typically offers B-scan images representing a section through the tissue while optical fluorescence imaging offers tissue surface images, at a high resolution with relatively low technological complexity and significantly lower cost.

However, extracting functional information about the disease state in vivo requires accurate, quantitative measurements of fluorescence. This is a major challenge, because the in vivo fluorescence depends on many parameters other than the concentration of the fluorescent marker which degrades the quantitative measurements. For example, variations in the tissue-to-detector geometry, autofluorescence and tissue optical properties, degrade the quantitative measurements such that the raw fluorescence image can be subject to several artifacts that compromise accurate quantification.

### SUMMARY

In a first aspect, at least one embodiment described herein provides a method for quantification of fluorescence from fluorophores in a region of interest of an object. The method comprises selecting at least one type of fluorophore from the region of interest; providing at least one excitation signal to the region of interest to produce fluorescence from the at least one type of fluorophore and to generate at least one reflectance signal; obtaining the produced fluorescence and reflectance signals from the region of interest; producing a quantified fluorescence signal for each of the resulting fluorescence signals by dividing by the corresponding reflectance signals; and calculating at least one ratio of the quantified fluorescence signals.

In a second aspect, at least one embodiment described herein provides a fluorescence imaging system for acquisition and quantification of fluorescence from a region of interest of an object. The system comprises a light source unit configured to produce at least one excitation signal that is provided to the region of interest to enable at least one fluorescence signal to be produced from at least one type of fluorophore in the region of interest and at least one reflectance signal to be produced from the region of interest; a detection unit configured to obtain the fluorescence and reflectance signals produced from the region of interest; and a data processing unit configured to calculate a quantified fluorescence signal for each of the produced fluorescence signals by dividing by the corresponding reflectance signals, and calculate at least one ratio of the quantified fluorescence signals.

In a third aspect, at least one embodiment described herein provides a method for quantification of fluorescence from fluorophores in a region of interest of an object. The method comprises selecting a single type of fluorophore from the region of interest; providing light energy at first and second excitation wavelengths to the region of interest corresponding to relative absorption maxima and minima of the fluorophore to produce first and second fluorescence signals at a similar emission wavelength from the fluorophore or providing light energy at an excitation wavelength to the region of interest to produce first and second fluorescence signals at a relative maxima and minima of the emission spectra of the fluorophore; obtaining the first and second fluorescence signals from the region of interest; calculating a ratio of the first and second fluorescence signals; and generating a final image of at least a portion of the region of interest based on the ratio.

In a fourth aspect, at least one embodiment described herein provides a method for quantification of luminescence originating from luminescent particles from a region of interest of an object. The method comprises obtaining at least one first type of signal from the region of interest; obtaining at least one second type of signal from the region of interest; calculating a quantified signal for the at least one first type of signal by dividing by the corresponding second type of signal; calculating at least one ratio of the quantified signals; and generating a final image of at least a portion of the region of interest based on one of the at least one ratios. The first type of signal comprises luminescence and the second type of signal comprises one of reflectance and luminescence that depends similarly on optical properties as the first type of signal.

### BRIEF DESCRIPTION OF THE DRAWINGS

For a better understanding of the various embodiments described herein and to show more clearly how they may be carried into effect, reference will now be made, by way of example only, to the accompanying drawings in which:

FIG. 1 shows a flow chart diagram of an exemplary embodiment of a method for acquisition and quantification of fluorescence signals;

FIG. 2 shows a schematic representation of an exemplary embodiment of a fluorescence imaging system for carrying out the method of FIG. 1;

FIGS. 3A-3C show schematic excitation and emission spectra of tissues containing various markers;

FIG. 4 is a graph showing the modeled absorption coefficient for deoxygenated blood, oxygenated blood and tissue as well as the reduced scattering coefficient for tissue;

FIGS. 5A and 5B show graphs of fluorescence intensity versus fluorophore concentration for raw and corrected fluorescence images respectively;

FIGS. 6A-6E demonstrate the potential usefulness of the methods described herein when applied to surgical resection.

FIGS. 7A-7E show red, blue and green pixel intensities, respectively, plotted against PpIX concentration, at varying working distances of excitation wavelength 1 (left row) and excitation wavelength 2 (right row) using varying proportions of PpIX extract in tissue-simulating phantoms (μₐ=1.9 cm⁻¹, μₛ′=8.0 cm⁻¹ at 635 nm); and

FIG. 8 shows a quantified signal calculated according to method Q₃ in a test case in which PpIX was used as a target fluorophore and Fluorescein was used as a reference fluorophore.

### DETAILED DESCRIPTION OF THE VARIOUS EMBODIMENTS

It will be appreciated that numerous specific details are set forth in order to provide a thorough understanding of the various embodiments described herein. However, it will be understood by those of ordinary skill in the art that the various embodiments may be implemented without these specific details. In other instances, well-known methods, procedures and components have not been described in detail so as not to obscure the embodiments described herein. Further, where considered appropriate, reference numerals may be repeated among the figures to indicate corresponding or analogous elements.

The word fluorophore used herein can be defined in many ways. A fluorophore can be considered to be a component of a molecule that causes the molecule to be fluorescent. A fluorophore absorbs energy of a specific wavelength and re-emits energy at a different, but equally specific, wavelength. Fluorophores can also be considered to be any fluorescent particle or portion of a particle. Such a particle can be naturally occurring or engineered. It can be untargeted, passively targeted or actively targeted by conjugating with a targeting moiety including, but not restricted to, antibodies, antibody fragments and peptides, or may employ any other targeting or non-targeting strategy.

Synonymous to fluorophores as described herein are: fluorescent dyes, fluorescent markers, fluorescent labels, fluorochromes, fluorescent biomarkers, molecular probes, microspheres, quantum dots, nanocrystals, fluorescent probes and any other terms used to describe fluorescent particles or fluorescent components of a particle. Historically common examples of fluorophores are fluorescein, porphyrins, rhodamine, coumarin, cyanine, phthalocyanines and any derivatives thereof. Newer generations of fluorophores include Alexa Fluors, DyLight, Fluorescent, green fluorescent protein, DsRED, fluorescent microspheres and nanocrystals. Fluorophores as described herein can, amongst other things, be endogenous or exogenous.

Various embodiments of methods and devices are described herein that can be used to generally acquire 2D fluorescence signals (i.e. image data) and subsequently correct these signals for artifacts caused by variations in excitation geometry, photodetector collection efficiency, autofluorescence, tissue absorption, e.g. blood oxygenation and blood volume, and tissue scattering in real-time based on ratiometric quantification. Accordingly, the methods are generally independent of variations in tissue autofluorescence, detector geometry, excitation geometry, tissue optical properties, irradiance and collection efficiency. The resulting signal, in effect, becomes independent of variation in the above parameters and provides quantitative rather than qualitative information about the fluorescent marker. The methods are also minimally dependent on tissue autofluorescence. The 2D fluorescence images are taken of a region of interest in an object that has embedded fluorophore markers or naturally occurring fluorophores that can be used with a method described herein. The methods can be used in vivo and can be used with a wide variety of fluorescent markers. These methods allow for an improved determination of fluorophore concentration, or alternatively determining the degree of quenching versus unquenching, in highly turbid media such as biological tissues by eliminating or reducing the contribution of parameters other than the fluorophore of interest. These ratiometric quantification methods can be used in conjunction with various applications such as endoscopic screening or image-guided surgery.

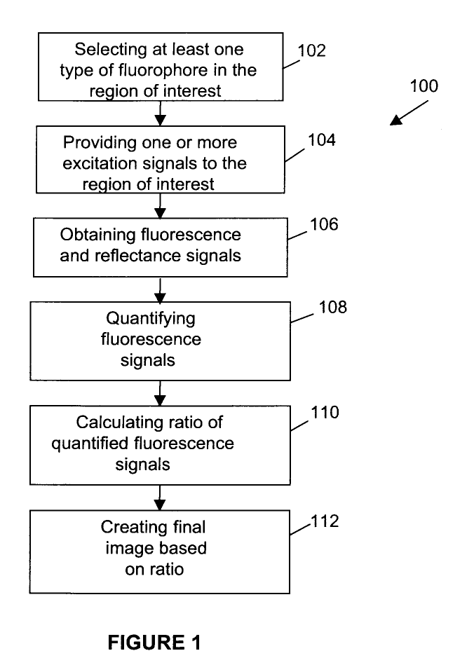

Referring now to FIG. 1, shown therein is a flowchart diagram for a general embodiment of a method 100 for acquiring and quantifying fluorescence signals. At step 102, at least one type of fluorophore is selected for a region of interest of the target object that is to be imaged. The one or more types of fluorophores are selected based on the physical properties of the region and the object of interest and the information that is desired. It will be appreciated that different combinations of fluorophores and object properties will yield different types of information about the region and object of interest. It should be noted that if the selected one or more types of fluorophore do not naturally occur in the region of interest then this step includes introducing or administering these one or more types of fluorophores to the region of interest. At step 104, one or more excitation signals at different excitation wavelengths are provided to the region of interest. The excitation signals correspond to the one or more types of fluorophores that are being imaged in that the excitation signals include energy at the proper excitation wavelengths to cause the one or more types of fluorophores of interest to fluoresce. In step 104, light is also provided to the region of interest such that reflectance signals are produced from the region of interest at wavelengths corresponding to those used for excitation.

At step 106, fluorescence and reflectance signals from the region of interest are obtained. The reflectance signals of interest include diffusely reflected signals, however, the reflectance signals may also include a portion of spectrally reflected signals. The diffuse reflectance signals are of interest because they similarly depend on the media optical properties as compared to the fluorescence signal. Thus, the diffusely reflected signal can be used to minimize the dependency of the fluorescence signal on optical properties.

At step 108, the fluorescence signals that have been obtained are quantified. This can be done by dividing an obtained fluorescence signal by a corresponding obtained reflectance signal; in this case the word corresponding generally means the reflectance signal obtained at the wavelength that was used to excite the fluorescence signal. However, it should be noted that in some embodiments of the method 100, reflectance signals are not required and division by a reflectance signal is not performed; rather division by another fluorescence signal is used as is discussed in further detail below with respect to quantification methods Q2 and Q3.

At step 110, at least one ratio of fluorescence or quantified fluorescence signals is calculated. At step 112, an image of the region of interest is created using at least one of the calculated fluorescence ratios. It should be noted that step 112 can optionally include overlaying at least two images, one of which is an image based on the calculated ratio. Also, it should be noted that in some cases step 112 can be optional in instances in which the information provided by the calculated ratio can be used in ways other than generating an image. Various embodiments of the method 100 exist, examples of which are now given.

In one exemplary embodiment, step 102 involves the introduction of only one type of fluorophore, and step 104 involves the use of two excitation signals having excitation wavelengths λₑₓ₁ and λₑₓ₂ respectively. Step 106 involves the measurement of fluorescence signals F(λₑₓ₁,λₑₘ₁) and F(λₑₓ₂,λₑₘ₁) both at an emission wavelength λₑₘ₁ and the measurement of reflectance signals R(λₑₓ₁) and R(λₑₓ₂) at the excitation wavelengths λₑₓ₁ and λₑₓ₂ respectively. The measured fluorescence and reflectance signals in this and other embodiments described herein are generally in units of mW/cm² and the wavelengths or bands described herein and in other embodiments are in units of nm. Step 108 involves the quantification of the fluorescence due to a given excitation wavelength by dividing by the reflectance at the given excitation wavelength according to F(λₑₓ₁,λₑₘ₁)/R(λₑₓ₁) and F(λₑₓ₂,λₑₘ₁)/R(λₑₓ₂) respectively. The ratio at step 110 is then calculated according to equation 1 by dividing the quantified fluorescence at the first excitation wavelength by the quantified fluorescence at the second excitation wavelength.

$${Q}_{1} = \frac{F ( {λ}_{ex 1} , {λ}_{em 1} )}{R ( {λ}_{ex 1} )} \cdot \frac{R ( {λ}_{ex 2} )}{F ( {λ}_{ex 2} , {λ}_{em 1} )} \qquad ( 1 )$$

To create the final image at step 112, the signals obtained at step 106 are two dimensional image signals and one performs the mathematical operations of steps 108 and 110 for each pixel of the two dimensional image signals. Accordingly, the final image can be the corrected fluorescence image. Alternatively, the final image can be a combination of the corrected fluorescence image and another image, such as a white light image, which is described in further detail below.

Accordingly, in this case the method 100 comprises injecting excitation light to a region of interest, such as a biological tissue, at a first and a second excitation wavelength, detecting fluorescence signal at an emission wavelength, measuring a reflectance signal from the region of interest at the first and second excitation wavelengths and providing a ratio of the fluorescence signals in which each signal is normalized with the reflectance signal at the corresponding excitation wavelength. Because the fluorescence at the different excitation wavelengths depends differently on tissue optical properties the method itself is dependent on optical properties. However, this is minimized by dividing by the reflectance signals that have similar dependencies on optical properties and the dependency on tissue optical properties largely cancels out.

In an alternative embodiment, a method Q₂ is performed using a single type of fluorophore, providing excitation at first and second wavelengths λₑₓ₁ and λₑₓ₂, and obtaining the resulting fluorescence signals F(λₑₓ₁, λₑₘ₁) and F(λₑₓ₂, λₑₘ₁) at the emission wavelength λₑₘ₁ for the fluorophore. The method Q₂ then provides a corrected fluorescence measurement by dividing the obtained fluorescence signals by one another as shown in equation 2.

$${Q}_{2} = \frac{F ( {λ}_{ex 1} , {λ}_{em 1} )}{F ( {λ}_{ex 2} , {λ}_{em 1} )} \qquad ( 2 )$$

One may expect that Q₂ provides a constant, however, this is not the case because a background signal is also obtained when the fluorescence signals are obtained and the division in equation 2 provides an initial slope that is useful in measuring low concentrations of this type of fluorophore in the region of interest. However, improved quantification results are obtained using methods Q₁, Q₃ and Q₄ (methods Q₃ and Q₄ are described below).

For method Q2, the step of providing excitation signals includes providing light energy at first and second excitation wavelengths to the region of interest corresponding to relative absorption maxima and minima of the fluorophore to produce first and second fluorescence signals at a similar emission wavelength from the fluorophore. Alternatively, this step can include providing light energy at an excitation wavelength to the region of interest to produce first and second fluorescence signals at a relative maxima and minima of the emission spectra of the fluorophore.

When the quantification method Q₁ is based on a ratio on relative maxima and minima of the absorption spectra, which is explained in further detail below, the response to the marker concentration is non-linear and reaches a plateau at higher concentrations, such that the concentration range that can be detected is limited. However, the quantification method Q₁ can be modified such that it has a linear response to marker concentration. This can be achieved by modifying the quantification method Q₁ for use with two markers with differences in absorption and/or emission spectra.

Accordingly, in another alternative embodiment of the method 100, the method is performed such that the quantification method results in a linear response to fluorophore concentration. This embodiment requires the use of two types of fluorophores including a target fluorophore and a reference fluorophore in the region of interest at step 102. In some cases, the target and/or reference fluorophores can be naturally occurring in the region of interest. In other instances, the target and/or reference fluorophores are added to the region of interest. The selection of the target fluorophore is based on the information desired and is expected to vary in concentration throughout the region of interest with a parameter of interest, while the reference fluorophore is expected to remain nearly uniformly distributed throughout the region of interest and act as a reference to which the target fluorophore is compared. Alternatively, there can be other instances in which the concentration of the target fluorophores is constant, but the fluorescence of the target fluorophores changes due to quenching and unquenching of the fluorescence of the target fluorophores. The target and reference marker fluorophores can be of any form, for example non-targeting, passively targeting, actively targeting, unconjugated, or conjugated to a single or multiple targeting moiety.

At step 104, two excitation signals at two different wavelengths λₑₓ₁ and λₑₓ₂ respectively are provided to the region of interest. Step 106 involves the measurement of fluorescence signals Fₜₐᵣ(λₑₓ₁,λₑₘ₁) and F_{ref}(λₑₓ₂,λₑₘ₂) at emission wavelengths λₑₘ₁ and λₑₘ₂ from the target fluorophore and the reference fluorophore respectively. Step 106 also involves the measurement of the reflectance signals R(λₑₓ₁) and R(λₑₓ₂) at the excitation wavelengths λₑₓ₁ and λₑₓ₂ respectively.

At step 108, the quantification of the fluorescence from the target fluorophore is with respect to the reflectance at the excitation wavelength used with the target fluorophore, i.e. Fₜₐᵣ(λₑₓ₁,λₑₘ₁)/R(λₑₓ₁), and the quantification of the fluorescence from the reference fluorophore is with respect to the reflectance at the excitation wavelength used with the reference fluorophore, i.e. F_{ref}(λₑₓ₂,λₑₘ₂)/R(λₑₓ₂). The ratio at step 110 is then calculated according to equation 3 by dividing the quantified target fluorescence by the quantified reference fluorescence in the event that the absorption and emission spectra of the target and reference fluorophores are different.

$${Q}_{3} = \frac{{F}_{tar} ( {λ}_{ex 1} , {λ}_{em 1} )}{r ( {λ}_{ex 1} )} \cdot \frac{R ( {λ}_{ex 2} )}{{F}_{ref} ( {λ}_{ex 2} , {λ}_{em 2} )} \qquad ( 3 )$$

In an alternative, the emission spectra for the target and reference fluorophores can be similar, but the absorption spectra can be different in which case the fluorescence signals are measured as Fₜₐᵣ(λₑₓ₁,λₑₘ₁) and F_{ref}(λₑₓ₂,λₑₘ₁) at wavelength λₑₘ₁, quantified as they were previously and the ratio is calculated according to equation 3′.

$${Q}_{3}^{′} = \frac{{F}_{tar} ( {λ}_{ex 1} , {λ}_{em 1} )}{R ( {λ}_{ex 1} )} \cdot \frac{R ( {λ}_{ex 2} )}{{F}_{ref} ( {λ}_{ex 2} , {λ}_{em 1} )} \qquad ( {3}^{′} )$$

In another alternative, the absorption spectra for the target and reference fluorophores can be similar, but the emission spectra can be different in which case the fluorescence signals are measured as Fₜₑᵣ(λₑₓ₁,λₑₘ₁) and F_{ref}(λₑₓ₁,λₑₘ₂) at wavelengths λₑₘ₁ and λₑₘ₂ and the ratio is calculated according to equation 3″. In this case, the reflectance signals do not have to be measured since they are with respect to the same excitation wavelength and will cancel out during the calculation of the ratio.

$${Q}_{3}^{″} = \frac{{F}_{tar} ( {λ}_{ex 1} , {λ}_{em 1} )}{{F}_{ref} ( {λ}_{ex 1} , {λ}_{em 2} )} \qquad ( {3}^{″} )$$

The various quantification methods Q₃ are dependent on variations in autofluorescence of the region of interest, however, this can also be dealt with in an alternative embodiment of the method 100. This alternative embodiment involves the introduction of two types of fluorophores, a target fluorophore and a reference fluorophore, to the region of interest at step 102 as was described for quantification method Q₃. Similarly, steps 104 and 106 are conducted as described for quantification method Q₃. However, step 106 also involves obtaining separate control measurements to be taken for both the target and reference fluorophores. The control measurements β_{1(Ctar=0)} and β_{2(Cref=0)}, are taken prior to the administration of the fluorophores to the region of interest or in a region with negligible dual fluorophore uptake such that the concentrations of the target and reference fluorophores, Cₜₐᵣ and C_{ref}, respectively are zero or negligible. The control measurements are defined in equation 4a.

$${β}_{1 ( {C}_{tar} \& {C}_{ref} = 0 )} = \frac{{F}_{tar} ( {λ}_{ex 1} , {λ}_{em 1} )}{{F}_{tar} ( {λ}_{ex 2} , {λ}_{em 1} )} and {β}_{2 ( {C}_{tar} \& {C}_{ref} = 0 )} = \frac{{F}_{ref} ( {λ}_{ex 2} , {λ}_{em 2} )}{{F}_{ref} ( {λ}_{ex 1} , {λ}_{em 2} )} \qquad ( 4 a )$$

At step 108, prior to quantifying the measured fluorescence signals with the measured reflectance signals, the control measurements are subtracted from the measured fluorescence signals. At step 110, the ratio is calculated as defined in equation 4b for the case in which the absorption and emission spectra of the target and reference fluorophores are different.

$${Q}_{4} = \frac{{F}_{tar} ( {λ}_{ex 1} , {λ}_{em 1} ) - {β}_{1} {F}_{tar} ( {λ}_{ex 2} , {λ}_{em 1} )}{R ( {λ}_{ex 1} )} \cdot \frac{R ( {λ}_{ex 2} )}{{F}_{ref} ( {λ}_{ex 2} , {λ}_{em 2} ) - {β}_{2} {F}_{ref} ( {λ}_{ex 1} , {λ}_{em 2} )} \qquad ( 4 b )$$

In an alternative, the emission spectra are similar for the target and reference fluorophores, but the absorption spectra are different. In this case, the fluorescence signals are measured as Fₜₐᵣ(λₑₓ₁,λₑₘ₁) and F_{ref}(λₑₓ₂,λₑₘ₁) at emission wavelength λₑₘ₁, and the control measurements are taken according to equation 4a′. The control measurements are then subtracted from the measured fluorescence signals and quantified as they were previously and the ratio is calculated according to equation 4b′.

$$\begin{matrix}{β}_{3 ( {C}_{tar} \& {C}_{ref} = 0 )} = \frac{{F}_{tar} ( {λ}_{ex 1} , {λ}_{em 1} )}{{F}_{tar} ( {λ}_{ex 2} , {λ}_{em 1} )} and {β}_{4 ( {C}_{tar} \& {C}_{ref} = 0 )} = \frac{{F}_{ref} ( {λ}_{ex 1} , {λ}_{em 1} )}{{F}_{ref} ( {λ}_{ex 2} , {λ}_{em 1} )} & ( 4 {a}^{′} ) \\ {Q}_{4}^{′} = \frac{{F}_{tar} ( {λ}_{ex 1} , {λ}_{em 1} ) - {β}_{3} {F}_{tar} ( {λ}_{ex 2} , {λ}_{em 1} )}{R ( {λ}_{ex 1} )} \cdot \frac{R ( {λ}_{ex 2} )}{{F}_{ref} ( {λ}_{ex 1} , {λ}_{em 1} ) - {β}_{4} {F}_{ref} ( {λ}_{ex 2} , {λ}_{em 1} )} & ( 4 {b}^{′} )\end{matrix}$$

In another alternative, the absorption spectra are similar for the target and reference fluorophores, but the emission spectra are different. In this case, the fluorescence signals are measured as Fₜₐᵣ(λₑₓ₁,λₑₘ₁) and F_{ref}(λₑₓ₁,λₑₘ₂) at wavelengths λₑₘ₁ and λₑₘ₂, and the control measurements are taken according to equation 4a″. The control measurements are then subtracted from the measured fluorescence signals and quantified as they were previously and the ratio is calculated according to equation 4b″.

$$\begin{matrix}{β}_{5 ( {C}_{tar} \& {C}_{ref} = 0 )} = \frac{{F}_{tar} ( {λ}_{ex 1} , {λ}_{em 1} )}{{F}_{tar} ( {λ}_{ex 1} , {λ}_{em 2} )} and {β}_{6 ( {C}_{tar} \& {C}_{ref} = 0 )} = \frac{{F}_{ref} ( {λ}_{ex 1} , {λ}_{em 2} )}{{F}_{ref} ( {λ}_{ex 1} , {λ}_{em 1} )} & ( 4 {a}^{″} ) \\ {Q}_{4}^{″} = \frac{{F}_{tar} ( {λ}_{ex 1} , {λ}_{em 1} ) - {β}_{5} {F}_{tar} ( {λ}_{ex 1} , {λ}_{em 2} )}{{F}_{ref} ( {λ}_{ex 1} , {λ}_{em 2} ) - {β}_{6} {F}_{ref} ( {λ}_{ex 1} , {λ}_{em 1} )} & ( 4 {b}^{″} )\end{matrix}$$

In another alternative embodiment of the method 100, the method can be performed such that more than one characteristic of the region of interest may be investigated. In this case, step 102 involves the selection of three types of fluorophores. Two of these types of fluorophores are target fluorophores based on the information desired and are expected to vary in concentration throughout the region of interest while the other type of fluorophore is a reference fluorophore expected to remain nearly uniformly distributed throughout the region of interest and acts as a reference to which the target fluorophores are compared. Alternatively, the target fluorophores can have a constant concentration and their fluorescence can be varied by quenching or unquenching as explained previously. Step 104 involves providing excitation at three wavelengths and step 106 involves measuring or obtaining the fluorescence and reflectance signals from each of the types of fluorophores. Step 108 then involves dividing the fluorescence signals for both target fluorophores by the corresponding reflectance signals and step 110 involves calculating two ratios, one for each target fluorophore, as defined in equations 5a and 5b for the case in which the absorption and emission spectra of the target fluorophores and the reference fluorophore are different. For N different target fluorophores, one can compute N corrected fluorescence images.

$$\begin{matrix}{Q}_{tar 1} = \frac{{F}_{tar 1} ( {λ}_{ex 1} , {λ}_{em 1} )}{R ( {λ}_{ex 1} )} \cdot \frac{R ( {λ}_{ex 2} )}{{F}_{ref 1} ( {λ}_{ex 2} , {λ}_{em 2} )} & ( 5 a ) \\ {Q}_{tar 2} = \frac{{F}_{tar 2} ( {λ}_{ex 3} , {λ}_{em 3} )}{R ( {λ}_{ex 3} )} \cdot \frac{R ( {λ}_{ex 2} )}{{F}_{ref 1} ( {λ}_{ex 2} , {λ}_{em 2} )} & ( 5 b )\end{matrix}$$

This alternative method can be varied by using two target fluorophores and two reference fluorophores. Step 104 involves providing excitation at four wavelengths and step 106 involves measuring the fluorescence and reflectance signals from each of the types of fluorophores. Step 108 then involves dividing the fluorescence signals for both target fluorophores by the corresponding reflectance signals and step 110 involves calculating two ratios, one for each target fluorophore, as defined in equations 5a′ and 5b′ for the case in which the absorption and emission spectra of the target fluorophores and the reference fluorophore are different.

$$\begin{matrix}{Q}_{tar 1} = \frac{{F}_{tar 1} ( {λ}_{ex 1} , {λ}_{em 1} )}{R ( {λ}_{ex 1} )} \cdot \frac{R ( {λ}_{ex 2} )}{{F}_{ref 1} ( {λ}_{ex 2} , {λ}_{em 2} )} & ( 5 {a}^{′} ) \\ {Q}_{tar {2}^{′}} = \frac{{F}_{tar 2} ( {λ}_{ex 3} , {λ}_{em 3} )}{R ( {λ}_{ex 3} )} \cdot \frac{R ( {λ}_{ex 4} )}{{F}_{ref 2} ( {λ}_{ex 4} , {λ}_{em 4} )} & ( 5 {b}^{′} )\end{matrix}$$

It will be appreciated by one of ordinary skill in the art that there can be other variations of the methods outlined above. For instance, the fluorescence and reflectance signals may be measured in sequence or simultaneously, depending on the emission wavelengths. For instance, if excitation at two different wavelengths provides emission at the same wavelength, then excitation at one of the wavelengths is done followed by measurement at the emission wavelength, and when emission has sufficiently subsided, excitation at the other wavelength can be done followed by measurement at the same emission wavelength. In another alternative, it can be possible to introduce a very high number of targeted fluorophores into the region of interest, along with any reference fluorophores as required, in order to monitor several different characteristics. Also by way of example, there may be times when certain ratios are more useful than others and the user may wish to have different results displayed as circumstances change.

In addition, it should be noted that for the methods that use a single type of fluorophore, the contrast in the final image will be maximized when one excitation wavelength corresponds with the absorption maximum of the fluorophore while the other excitation wavelength corresponds with the absorption minimum of the fluorophore. That being said, methods Q₁, Q₂ and Q₄ can be done by using off-maxima excitation or off-minima excitation in which there may be some degradation in the final results but the performance is still better than that which can be achieved using conventional techniques. Accordingly, the excitation wavelengths for λₑₓ₁ and λₑₓ₂ used for methods Q₁, Q₂ and Q₄ can correspond to a relative absorption maximum and a relative absorption minimum of the fluorophore, such that there is enough of a difference in absorption for the fluorophore at the different excitation wavelengths that are used to provide good image correction results. In other words, a first wavelength can be selected from a range that includes the wavelength at which maximum absorption occurs, i.e. selected from a band that includes the wavelength for maximum absorption, and then the second wavelength can be selected from a range that includes the wavelength at which minimum absorption occurs. In this way, the wavelengths at which maximum and minimum absorption occurs may not be exactly selected but the wavelengths are selected such that there is enough of a difference in the resulting fluorescence signals so that the corrected image will be useful although it the results may not be optimal.

It should also be noted that for the excitation and emission wavelengths described herein, energy at these wavelengths can be provided or measured in a broadband or a narrowband (including just the wavelength of interest) fashion. In addition, the reflectance signal can be a narrowband signal or it can be a broadband reflectance including white light reflection.

It should also be noted that useful information and correction can be obtained by inverting the ratios used for the final calculation in each of the quantification methods.

It should also be noted that these different methods can also be used with luminescence and/or fluorescence standards, to further improve quantification by minimizing day-to-day and experiment-to-experiment intra-device variation and by minimizing inter-device variations through cross calibrations. Examples of such standards are Anthracene, Napthalene, p-Terphenyl, Tetraphenylbutadiene, Compound 601, Rhodamine B, SRM 1932—Fluorescein Solution (NIST), and SRM 936a—Quinine Sulfate Dihydrate (NIST). Another example of the use of these methods with a fluorescent standard is during surgical image guided resection in which the standard can be placed in the surgical cavity to further aid quantification.

In usage with a standard, a calibration measurement of a fluorescent crystal can first be taken, prior to any experimental measurements. For instance, a fluorescent crystal sphere (e.g. ruby sphere) of approximately 1 mm diameter can be mounted on a thin rod. This sphere can be characterized by measuring the fluorescence intensity versus distance to a photodetector. This can then be used as an intraoperative standard that can be placed in the surgical cavity, since at a known distance this gives a known fluorescence without dependencies on geometry, autofluorescence, tissue optical properties, etc. This, for example, can demonstrate the degradation of any light sources or detectors that are used.

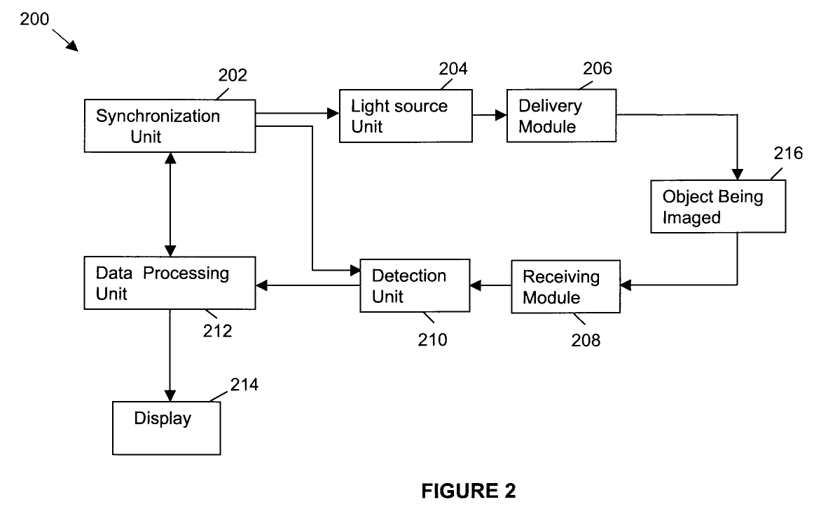

Referring now to FIG. 2, shown therein is a schematic representation of an exemplary embodiment of a fluorescence imaging system 200 that can be used to carry out the acquisition and quantification of fluorescence signals from a region of interest. The system 200 enables the acquisition of an image processed by the various aforementioned methods described previously. As such the system 200 generally comprises optical means allowing for the acquisition of fluorescence and reflectance signals at multiple wavelengths as required. The acquisition rate of the system 200 is generally high enough to provide real-time imaging; for example, image acquisition rates on the order of 30 frames per second can be achieved.

The system 200 comprises a synchronization unit 202, a light source unit 204, a delivery module 206, a receiving module 208, a detection unit 210, a data processing unit 212 and a display 214. It will be appreciated by one of ordinary skill in the art that there are many possible ways to implement the system 200. Each component can be implemented and interconnected in a variety of ways, which can be selected based on the desired application for the system 200 as well as the equipment and resources available. These components are now described and an exemplary prototype system is described in further detail below in conjunction with experimental results.

A timing signal is sent from the synchronization unit 202 to the light source unit 204 for creating the required signals. An additional timing signal is sent to the detection unit 212, which then prepares to receive measured signals including fluorescence and reflectance signals, depending on the particular quantification method that is used. One or more excitation signals are sent to the delivery module 206 to be delivered to the region of interest of an object 216 that is being imaged. The region of interest then generates fluorescence and reflectance signals, which are transmitted to the detection unit 210 via the receiving module 208. The detection unit 210 transduces and measures the fluorescence and reflectance signals, depending on the quantification method that is used. The detection unit 210 then transmits the measured signals to the data processing unit 212, where the measured signals are processed according to one of the aforementioned methods described herein. The data processing unit 212 also receives a timing signal from the synchronization unit 202 to synchronize operation with the other components of the system 200.

The synchronization unit 202 is any device capable of synchronizing the operation of the light source and detection units so that the timing of the generation of the excitation signals as well as the measurement and processing of the fluorescence and reflectance signals generated by each excitation signal can be timed properly. In alternative embodiments, the synchronization unit 202 does not have to be used since one of units 204, 210 and 212 can each provide a master synchronization signal to which the other components of the system 200 can be operated as slaves as required.

The light source unit 204 includes one or more light sources, and optionally additional components, for generating one or more excitation signals that include energy at one or more excitation wavelengths as required by the particular fluorophore or fluorophores that have been delivered to the region of interest as well as for generating at least one reflectance signal from the region of interest when needed. Accordingly, the light source unit 204 provides single or multi-wavelength excitation. For example, the light source unit 204 can include a lamp positioned behind a fast rotating filter wheel with different excitation filters (elements not shown). The type of lamp and excitation filters that are used are selected to provide excitation at the proper wavelengths or bands based on the fluorophores that are used as well as to get the resulting reflectance signals when needed, according to the aforementioned methods described herein. The light source unit 204 also leaks a small fraction (approximately 10⁻³ to 10⁻⁴) of light at the excitation wavelengths for the measurement of the reflectance used in the ratiometric measurements. The light source unit 204 can also illuminate the region of interest by providing white light for example so that white light images can be taken as is described in more detail below. The excitation is performed such that it is synchronized to the output frequency of the detection unit 210 or vice-versa. For example, the filter wheel can be synchronized to the detection unit 210 such that every frame of data measured by the detection unit 210 can correspond with a different excitation filter at a desired rate, such as 30 frames per second, for example.

The delivery and receiving modules 206 and 208 are capable of transmitting the excitation light signals from the light source unit 204 to the object 208 being imaged and transmitting the resulting fluorescence and reflectance signals from the object 208 to the detector unit 210 respectively. The delivery and receiving modules 206 and 208 can be fiber optic bundles or other suitable light guides. While not strictly necessary to the functionality of the system 200, the delivery and receiving modules 206 and 208 are helpful in certain medical applications since the region of interest is often inside a patient in which case bringing the light source unit 204 and the detector unit 210 directly to the region of interest may be impractical under certain circumstances. In certain medical applications, the delivery and receiving modules 206 and 208 can be combined into a single instrument, such as a laparoscope or an endoscope.

The detection unit 210 generally includes spectral separation and detection components that are capable of separating light provided by the receiving module 208 into different spectral wavelength bands and subsequently detecting and/or measuring the light in these spectral wavelength bands. The spectral wavelength bands correspond to the emission and reflectance wavelength measurements of the fluorophores that are used in the region of interest according to one of the aforementioned methods described herein.

The spectral separation components can be implemented in a variety of ways and generally include, but are not limited to, single or multiple prisms with or without dichroic coatings, single or multiple gratings, single or multiple filter wheels or other filter switching mechanisms, an RGB mosaic filter or a tunable filter (e.g. liquid, crystal, acousto-optical, Fabry-Perot) or combinations thereof where appropriate. The implementation of the spectral separation components is such that the measured light signals are isolated or narrowed to a spectral band of appropriate size to capture the emission and reflectance signals that are being measured. For example, a detection band can range from 30 to 50 nm Full Width at Half Maximum (FWHM), but depending on the circumstances could be anywhere from 1 to 100 nm FWHM, or broader.

The detection components can also be implemented in a variety of ways, and generally include but are not limited to photomultiplier tubes, charge coupled devices (i.e. CCD, EMCCD, ICCD), photodiodes, CMOS detectors, a CCD camera, or other suitable photo detectors arranged in such a way as to provide two-dimensional image information for the spectral band of interest.

Based on the variety of spectral separation and detection components, the detection unit 210 can be implemented in a variety of ways. For instance, in one exemplary implementation, the spectral separation components include 3 prisms with dichroic mirrors, which separate the incoming light into 3 different wavelength bands: red, green and blue. Each wavelength band is detected with a photo detector such as a charge coupled device (CCD) creating red, green and blue image frames. The color of each of these frames corresponds to a wavelength that is being measured according to one of the aforementioned quantification methods described herein. If more than three measurements are required than additional spectral separator and detection components can be added as required.

In another exemplary implementation, the detection unit 210 includes multiple photosensitive layers to separate light into different spectral wavelength bands and a light detector, such as a CMOS detector, is used to detect the light in these spectral wavelength bands. For example, 3 photosensitive layers can be used to separate the incoming light into 3 different wavelength bands: red, green and blue to allow for the creation of red, green and blue image frames. If more than three measurements are required than additional spectral separator and detection components can be added as required. For instance, N layers are needed for N wavelength bands.

If image processing speed is important, ideally one wants to collect all signals simultaneously as fast acquisition leads to faster processing of the final image. As an example looking at method Q₁, four signals are needed with 2 different excitation wavelengths. One option is to collect these signals with a single CCD and a filter wheel such that one collects 4 images sequentially. If each image acquisition takes 1 second the total time required is 4 seconds. Alternatively, one could design optics that focuses all 4 signals at a single CCD and the acquisition time has decreased to 1 second. Similarly, one can use 4 CCD detectors in parallel and have an acquisition time of 1 second.

For example, when using the method Q₃ in case that the emission spectra are similar, but the absorption spectra are different, the filter wheel in the light source unit switches to a position ex1 and the generated fluorescence signal (F_{ex1,em1}) in the red wave band is detected by the red channel of a 3 CCD camera. The blue reflectance signal (Rₑₓ₁) is measured in parallel in the blue channel. This takes about 30 ms. Subsequently, the filter wheel changes to a position ex2 to provide a different excitation signal, a fluorescence signal is generated (F_{ex2,em1}) at the same red wavelength in the red channel of the 3 CCD camera, but at a different yield, and the blue reflectance signal (Rₑₓ₂) is measured on the blue channel, which takes about another 30 ms.

One of ordinary skill in the art will understand that the choice of spectral separation and detection components depends on the information sought, the nature of the object of interest, the equipment available and any other resources available. A person of ordinary skill in the art will be able to choose the proper spectral separation and detection components based on the particular circumstances.

The data processing unit 212 is any device capable of receiving the raw image data streams, and processing the raw image data according to at least one the aforementioned methods described herein to generate the final image. Accordingly, the data processing unit 212 can perform mathematical and image processing functions as needed by these aforementioned methods, in which these functions include at least one of subtraction, addition, multiplication, division, and superimposing or overlaying.

The data processing unit 212 can be a processor, or a personal computer for example that executes computer software code for performing at least one of the fluorescence quantification methods described herein. Alternatively, the data processing unit 212 can be implemented with at least one of an Application Specific Integrated Circuit (ASIC) or a Digital Signal Processor (DSP) to perform the fluorescence quantification methods described herein. The data processing unit 212 can also generate white light images of the region of interest in concert with the other components of the system 200. In at least some implementations, the data processing unit 212 can generate final images at a rate of 30 frames per second. In some embodiments, the synchronization unit 202, the data processing unit 212 and possibly the display 214 can be implemented with a personal computer.

In an alternative, while performing any one of the aforementioned methods described herein, the data processing unit 212 can also augment the color images received from the detection unit 210 to improve contrast between normal and tumour tissue. For example, when processing Red, Green, and Blue (i.e. RGB) images to produce the final image, the data processing unit 212 can augment or attenuate at least one of these images depending on the spectral band that exhibits the highest contrast between normal to tumour tissue. The data processing unit 212 can integrate the dual excitation and RGB color components into a real time composite video that can be tailored to enhance any number of fluorophores. Accordingly, the system 200 can be customizable for a large array of surgical applications.

A general problem with fluorescence correction methods is that the structural or anatomical information is mostly lost. This is problematic when the images are used to image a biopsy or a tumor resection at various times during the procedure. To alleviate this problem, the data processing unit 212 can superimpose or overlay the image obtained through application of these methods over top of another image, and display both images concurrently. For instance, the data processing unit 212 can superimpose or overlay the corrected fluorescence images on the raw fluorescence images or white light images, to provide both structural information for orientation, which can be used for surgical guidance, as well as functional information. This can be done in real-time (i.e. at 30 frames/sec).

In addition, prior to overlaying the corrected image on the raw fluorescence image or a white light image, the corrected image can be processed such that an area of interest (e.g. hotspot) remains, but the surrounding pixels are set to an intensity of zero. This then results in a white light or raw fluorescence image with an overlayed quantitative hotspot according to one of the aforementioned methods described herein.

A modeling study was conducted to demonstrate the performance of the various aforementioned methods described herein. The correction performance of these methods was evaluated by describing the method analytically using mathematical descriptions for fluorescence emission from turbid media, defining standard input parameters and introducing variations around these standard values. In this modeling study, one parameter was varied at a time, with the other parameters fixed at their standard value. As a measure of the quantification or correction performance, a factor CP was defined as the change in the corrected signal due to the introduced variations relative to a signal with standard input parameters. A Signal Change index SCₚₐᵣₐₘₑₜₑᵣ was calculated as the maximum divided by the minimum correction performance and the total signal change SCₜₒₜₐₗ was defined as the product of the signal changes due to the individual parameters, at fixed target fluorophore concentration. A value of 1.50 for SCₜₒₜₐₗ can be interpreted as a variation in output signal of less than ±25%.

The fluorescence and diffuse reflectance are represented by F(λₑₓ,λₑₘ) and R(λₑₓ) in mW/cm², where λₑₓ and λₑₘ stand for the excitation and emission wavelengths in nm, respectively as summarized in Table 1. The raw fluorescence signal Q_{Raw} uses a single excitation wavelength in the Ultra Violet (UV) to blue light range and a second single emission wavelength in the far red to Near-InfraRed (NIR) range and is defined in equation 6.

Q_{Raw}=F(λₑₓ₁,λₑₘ₁) (6)

The quantification method Q₁, defined previously in equation 1, employed the first excitation wavelength at an absorption maximum of the fluorescent marker (a red fluorescent marker) and the second excitation wavelength at an absorption minimum of the fluorescent marker.

TABLE 1
Chosen excitation and emission wavelengths

| Method | Marker | λₑₓ₁ | λₑₓ₂ | λₑₘ₁ |
|---|---|---|---|---|
| Q_{Raw} | PpIX | 406 | | 630 |
| Q₁ | PpIX | 406 | 436 | 630 |
| Q₂ | PC4 | 686 | 650 | 710 |
| Q₃ | Dual1 | 620 | | 700 |
| Q₃ | Dual2 | 730 | | 800 |
| Q₄ | Dual1 | 620 | 640 | 700 |
| Q₄ | Dual2 | 730 | 750 | 800 |

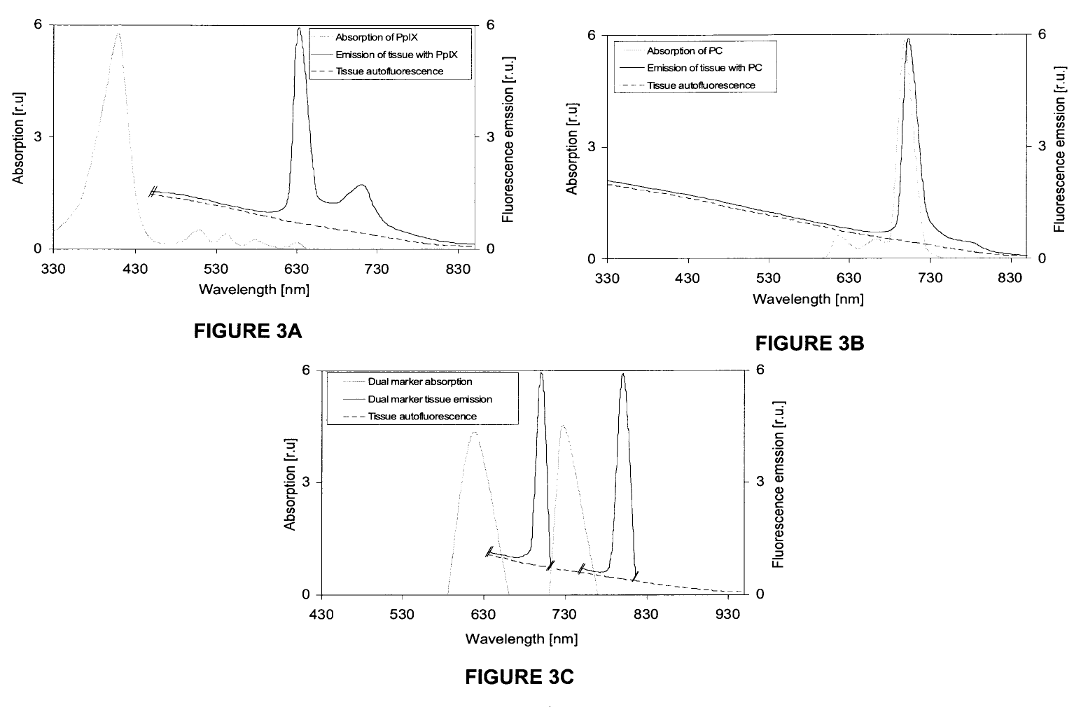

Protoporhyrin IX (PpIX) was used as the model fluorescent marker. It will be appreciated that other fluorescent markers can be used. The excitation and emission spectra are shown in FIGS. 3A-3C. FIGS. 3A-3C show, respectively, a schematic representation of the excitation (grey line) and emission (black line) spectra of tissues containing the fluorophore Protoporhyrin IX (PpIX), Phthalocyanine 4 (PC4) and a Dual fluorescent marker (DM). The dashed line shows the tissue auto fluorescence. Both the PpIX fluorescence and the tissue autofluorescence, were based on previous measurements in human subjects (Wilson B C, Weersink R A, and Lilge L (2003), Fluorescence in Photodynamic Therapy Dosimetry, In Handbook of biomedical fluorescence. M. Mycek and B. W. Pogue, Eds. Marcel Dekker, Inc., New York. pp. 529-561).

The fluorescence and diffuse reflectance at the tissue surface were described by analytical solutions to the diffusion equation as shown in equations 7a-7c. These formalisms used here are valid for excitation in the entire UV-NIR wavelength range and have been validated and demonstrated accuracy similar to Monte Carlo modeling (Farrell T J and Patterson M S (2003), Diffusion modeling of fluorescence in tissue, In Handbook of biomedical fluorescence, M. Mycek and B. W. Pogue, Eds. Marcel Dekker, Inc., New York. pp. 29-60).

$$\begin{matrix}R ( {λ}_{ex} ) = ηγ [ V + W ] & ( 7 a ) \\ F ( {λ}_{ex} , {λ}_{em} ) = ηγ [ X + Y + Z ] & ( 7 b ) \\ \begin{matrix}V = - W \frac{1 + 1.82 D ( {λ}_{ex} ) {μ}_{eff} ( {λ}_{ex} )}{1 + 1.82 D ( {λ}_{ex} ) {μ}_{eff} ( {λ}_{ex} )} , \\ W = \frac{{μ}_{s}^{′} ( {λ}_{ex} ) I ( {λ}_{ex} )}{D ( {λ}_{ex} )} \cdot \frac{1}{{μ}_{t}^{′2} ( {λ}_{ex} ) - {μ}_{eff}^{2} ( {λ}_{ex} )} \\ X = - Y \frac{1 + 1.82 D ( {λ}_{em} ) {μ}_{eff} ( {λ}_{ex} )}{1 + 1.82 D ( {λ}_{em} ) {μ}_{eff} ( {λ}_{em} )} - Z \frac{1 + 1.82 D ( {λ}_{em} ) {μ}_{t}^{′} ( {λ}_{ex} )}{1 + 1.82 D ( {λ}_{em} ) {μ}_{eff} ( {λ}_{em} )} \\ Y = - \frac{- V [ {C}_{m} M ( {λ}_{ex} , {λ}_{em} ) + {C}_{a} A ( {λ}_{ex} , {λ}_{em} ) ]}{D ( {λ}_{em} ) [ {μ}_{eff}^{2} ( {λ}_{ex} ) - {μ}_{eff}^{2} ( {λ}_{em} ) ]} , \\ Z = \frac{[ W + I ( {λ}_{ex} ) ] [ {C}_{m} M ( {λ}_{ex} , {λ}_{em} ) + {C}_{a} A ( {λ}_{ex} , {λ}_{em} ) ]}{D ( {λ}_{em} ) [ {μ}_{t}^{′2} ( {λ}_{ex} ) - {μ}_{eff}^{2} ( {λ}_{em} ) ]}\end{matrix} & ( 7 c )\end{matrix}$$

The dimensionless functions, γ and η represent the influence of geometry on the excitation irradiance and the collection efficiency of the photo detector, respectively. The parameters Cₘ and Cₐ represent the fluorophore and autofluorophore concentrations [M] respectively, with fluorescence yields, M(λₑₓ,λₑₘ) and A(λₑₓ,λₑₘ) [cm⁻¹.M⁻¹], respectively. The excitation irradiance is given by I(λₑₓ) [mW/m²]. The parameter D(λ) is the optical diffusion coefficient, D(λ)=[3′ₜ(λ)]⁻, where μ′ₜ(λ) [cm⁻¹] is given by μ′ₜ(λ)=μ′ₛ(λ)+μₐ^{total}(λ). The parameters λ′ₛ(λ) is the reduced scattering coefficient and μₐ^{total}(λ) is the absorption coefficient of the tissue fluorophores (target plus auto), so that μₐ^{total}(λ)=μₐ^{tissue}(λ)+μₐ^{fluorophores}(λ). The effective attenuation coefficient μ_{eff}(λ) is given by μ_{eff}(λ)=\sqrt{3μₐ^{total}(λ)[μₐ^{total}(λ)+μ′ₛ(λ)]}. The absorption of the tissue was considered much larger than that of the fluorescent marker plus the autofluorophores, i.e. (μₐ^{tissue}>>μₐ^{marker+autofluor}), so that μₐ^{marker+autofluor} was negligible in calculating D(λ)_{,} μ′ₜ(λ) and μ_{eff}(λ).

The standard values for optical properties of biological tissues were determined using the model by Svaasand et al. (Svaasand L O, Norvang L T, Fiskerstrand E J, Stopps E K S, Berrns M W, and Nelson J S (1995), Tissue parameters determining the visual appearance of normal skin and port-wine stain, Lasers in Med Sci., 10, pp. 55-65). According to this reference, the parameters that dominate absorption of human skin in the visible to near-infrared wavelength range are blood volume, blood oxygenation and melanin content.

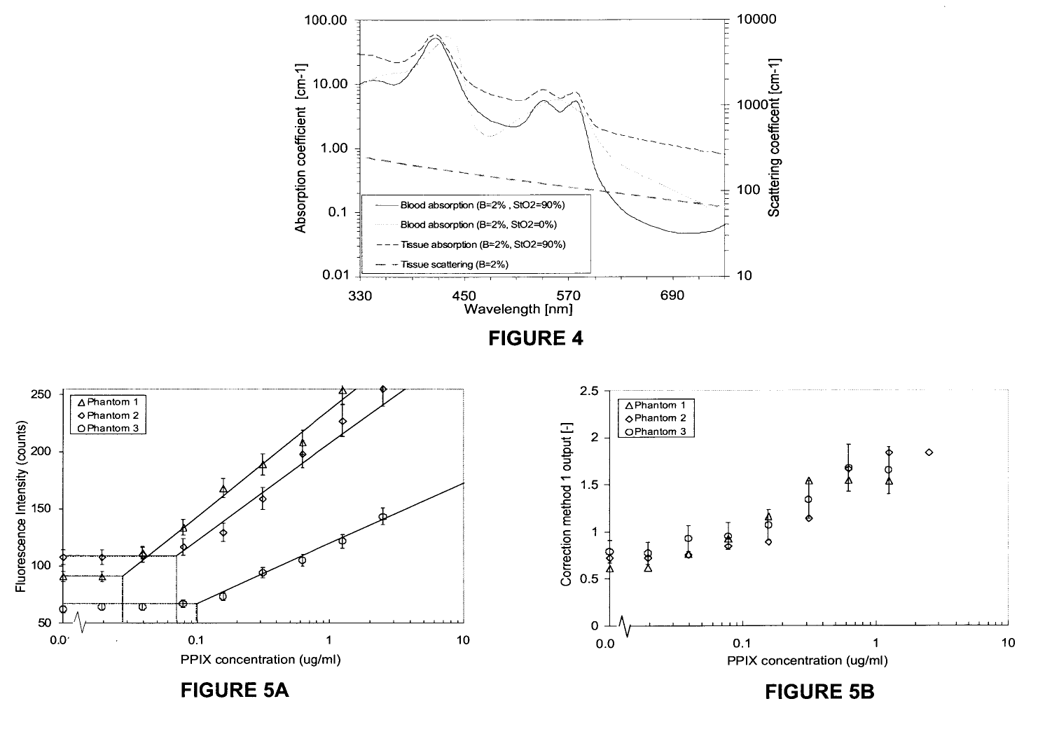

Since most tissues other than skin contain no melanin, the model was modified by decreasing the melanin content by a factor of 3 from that of Caucasian skin (at 694 nm), so that it can be used to represent unknown absorbers. This modified model produces optical properties that are generally more representative of tissues that do not contain melanin (Cheong W-F (1995), Appendix to chapter 8: Summary of optical properties, In Optical-Thermal Response of Laser-Irradiated Tissue, A. J. Welch and M. J. C. van Gernert, Eds. Plenum Press, New York, pp. 275-303) and at 630 nm, were in the range of brain white matter (Yavari N, Dam J S, Antonsson J, Wardell K, and Andersson-Engels S (2005), In vitro measurements of optical properties of porcine brain using a novel compact device, Med Biol Eng Comput. 43, pp. 658-66). FIG. 4 shows the modeled values for the absorption coefficient for deoxygenated (grey line) and 90% oxygenated (StO₂) (solid line) blood, tissue (dashed), and the reduced scattering coefficient of tissue (grey dashed). The blood volume (B) is 2%.

The standard values for fluorescence yields M(λₑₓ,λₑₘ) and A(λₑₓ,λₑₘ) are listed in Table 2. These were assumed constant. Their relative magnitudes were estimated based on the excitation and emission spectra shown in FIGS. 3A-3C.

TABLE 2
Modeled fluorescence yields used in the quantification methods.

| Marker | λₑₓ, λₑₘ [nm] | M [a · u] | A [a · u] |
|---|---|---|---|
| PpIX | 406, 630 | 16 | 2 |
| | 436, 630 | 4 | 1.8 |
| PC4 | 656, 710 | 4 | 0.2 |
| | 686, 710 | 16 | 0.18 |
| DF | 620, 700 | 16 | 0.22 |
| | 640, 700 | 4 | 0.20 |
| | 730, 800 | 16 | 0.15 |
| | 750, 800 | 4 | 0.13 |

The standard values for the remaining parameters and the range over which they were varied are listed in Table 3. Listed values for the parameters I, γ, η and Cₐ were chosen rather arbitrarily, as literature values are not widely available, however ranges for B, StO₂ and μ′ₛ span reported values for normal and cancerous tissues (Bogaards A, Sterenborg H J C M, and Wilson B C (2007), In vivo quantification of fluorescent molecular markers in real-time: a review study to evaluate the performance of five existing methods, Photodiagnosis and Photodynamic Therapy, in press; van Veen R L, Sterenborg H J, Marinelli A W, and Menke-Pluymers M (2004), Intraoperatively assessed optical properties of malignant and healthy breast tissue used to determine the optimum wavelength of contrast for optical mammography, J Biomed Opt. 9, pp. 1129-36; Cheong W-F (1995), Appendix to chapter 8: Summary of optical properties, In Optical-Thermal Response of Laser-Irradiated Tissue, A. J. Welch and M. J. C. van Gemert, Eds. Plenum Press, New York, pp. 275-303).

TABLE 3
Standard values and ranges for parameters used in modeling

| Parameter | Standard | Range | Unit | Reference |
|---|---|---|---|---|
| I | 100 | 30-100 | mWcm⁻² | Bogaards et al. |
| γ, η | 1.0 | 0.3-1.0 | r · u | Bogaards et al. |
| Cₘ | 0.01 | Fixed | M | — |
| Cₐ | 0.01 | 0.002-0.02 | M | Bogaards et al. |
| B | 2 | 1-10 | % | van Veen et al. |
| StO₂ | 90 | 30-90 | % | van Veen et al. |
| μ′ₛ | 1.0 | 0.1-1.0 | r · u. | Cheong |

Table 4 shows the results of the modeling study which include the signal change due to variations in the individual parameters, SCₚₐᵣₐₘₑₜₑᵣ, and the total signal change, SCₜₒₜₐₗ, for each quantification method and each marker. The quantification method Q₁ demonstrated a quantification performance of SCₜₒₜₐₗ=1.59, which can be interpreted as a variation in the output signal of approximately less than ±30%. This is an improvement of more than 2 orders of magnitude as compared to the raw fluorescence (SDₜₒₜₐₗ=245). Also, the quantification method Q₁ allows less sensitive detectors with a lower dynamic range to be employed as it measures diffuse reflectance instead of autofluorescence.

In addition, the ratio used in the quantification method Q₁ cancels out variations in irradiance, excitation geometry and collection efficiency. A small fraction of autofluorescence plus a large fraction of marker fluorescence present in both numerator and denominator minimizes the dependence on variations in autofluorescence. Correction for optical properties is achieved by representing these equally in the numerator and denominator by combining fluorescence and reflectance. To demonstrate the effect of the reflectance term in the quantification method Q₁, the performance was also modeled without it, which is referred to as Q₂. The quantification method Q₂ also had a decreased performance (SCₜₒₜₐₗ=2.97) as compared to Q₁ (SCₜₒₜₐₗ=1.59) demonstrating that use of the reflectance term minimizes the dependency on optical properties.

TABLE 4
Results of Modeling Study (Indep.: Independent by definition)

| Method | Marker | Linear | SC_{I, γ, η} | SC_{Ca} | SC_{B} | SC_{StO2} | SC_{μs} | SCₜₒₜₐₗ |
|---|---|---|---|---|---|---|---|---|
| Q_{Raw} | PpIX | Yes | 3.33 | 1.22 | 4.47 | 1.07 | 1.14 | 245 |
| Q₁ | PpIX | No | Indep. | 1.23 | 1.03 | 1.17 | 1.07 | 1.59 |
| Q₂ | PpIX | No | Indep. | 1.24 | 1.21 | 1.77 | 1.12 | 2.97 |
| Q₁ | PC4 | No | Indep. | 1.08 | 1.01 | 1.01 | 1.02 | 1.12 |
| Q₃ | Dual | Yes | Indep. | 1.07 | 1.05 | 1.05 | 1.04 | 1.23 |
| Q₄ | Dual | Yes | Indep. | Indep. | 1.02 | 1.05 | 1.04 | 1.11 |

The quantification method Q₁ can be used with markers that absorb and emit in the NIR range such as phthalocyanine 4 (PC4). Due to the decreased autofluorescence, blood absorption and scattering in the NIR, the performance further improved to SCₜₒₜₐₗ=1.12, as listed in Table 4.

Two markers are used, as per method Q₃, with different absorption and emission spectra conjugated to a single targeting moiety, as shown in FIGS. 3A-3C. The fluorescence of one marker can vary to yield functional disease information, whereas the fluorescence of a second marker is used as reference and assumed constant. For Q₃, the performance is SCₜₒₜₐₗ=1.23 as listed in Table 4 is in a similar range as compared to Q₁ with PC4, but has the additional advantage of a linear response to marker concentration. When Q₃ was modified as per method Q₄, the performance further improves to SCₜₒₜₐₗ=1.11.

It has been found that for fluorescence quantification with optimum accuracy, the fluorescent layer can be exposed to the tissue surface and should be thick relative to the penetration depth of light. Hence, UV/blue excitation light can be used for quantification of fluorescence in small lesions of a few mm in depth whereas far red/NIR light excitation can be used for thicker lesions. This is because the effective penetration depth of UV versus NIR light changes from the sub-millimeter range to several millimeters.

A study was also conducted using a prototypical clinical version of the fluorescence imaging system 200 on optical phantoms having different optical properties as well as patients undergoing radical prostatectomy. The light source unit 204 included a custom-made 300 Watt Xeon arc lamp (Cermax, Perkin Elmer, US) and a filter wheel containing 2, 4 or 8 excitation (or white light) filters. The synchronization unit 202 ensured that the filter wheel spun at a frequency so that subsequent frames were excited or illuminated with alternating wavelengths and were properly measured by the detection unit 210. Excitation wavelengths that were used were 406 nm and 436 nm. The excitation irradiance was approximately 50 mW/cm² at a typical working distance of 2 cm. Alternatively, a broadband optical density filter can also be installed in the filter wheel to obtain a white light reflectance image in addition to a fluorescence image. A standard clinical laparoscope with a liquid light guide served as the delivery and receiving modules 206 and 208. A 3-CCD compact surgical camera (DXC-C33, Sony, Canada) served as the detection unit 210. Multi-spectral images were acquired using the blue, green and red channels. The camera's sensitivity towards the NIR was extended by replacing the standard NIR cut-off filter. The 3-CCD camera featured a frame rate of 30 frames/sec (NTSC), 796×494 pixels and 8 bit dynamic range. A long-pass 500 nm filter (Chroma, US) was also placed between the camera and the laparoscope to leak a small fraction of the UV/blue excitation light for measurement of the diffuse reflectance. The long-pass filter was designed to allows a small fraction of the excitation light to leak though while also allowing transmission of fluorescence signals. This filter allows for blue reflectance measurements over a sufficiently wider wavelength range, such that it can transmit the reflectance of multiple excitation wavelengths over a relatively large bandwidth in the blue wavelength range. This provides improved structural/anatomical information. A computer (Intel, Pentium 4) served as the data processing unit 212. The digital video output from the 3-CCD camera was captured by the computer and could be displayed on the monitors in the operating room for visualization hence allowing surgical guidance. Image processing was performed on the computer using LabVIEW™ software (National Instruments, US).

Experimental performance evaluation was conducted in tissue equivalent phantoms with Intralipid-20% as a scattering medium and Evans Blue as an absorber. These were prepared with 3 different sets of μₐ and μ′ₛ at 630 nm. Values are listed in Table 5 and fall within ranges used in the modeling study. In these experiments, the parameters I, γ, and η were held constant. The marker PpIX (Sigma-Aldrich, Canada) was used as the single fluorophore. Prior to use, the phantoms were shaken continuously for 72 hours to allow PpIX to bind to the lipids. The raw fluorescence and the signal output of the quantification method Q₁ were determined over a PpIX concentration range of 0.01 to 10 μg/ml. The lower detection limit of the marker PpIX was also investigated.

TABLE 5
Optical Phantom Properties at 630 nm

| | μ′ₛ | μₐ |
|---|---|---|
| Phantom | [cm⁻¹] | [cm⁻¹] |
| 1 | 15 | 0.25 |
| 2 | 30 | 0.5 |
| 3 | 60 | 1 |

It was observed that the raw fluorescence and data from the Q₁ quantification method increased with increasing PpIX concentration as shown in FIGS. 5A and 5B. The raw fluorescence signals shown in FIG. 5A demonstrate a large deviation in response signals between the 3 phantoms. At a PpIX concentration of 1.25 μg/mg, the maximum difference between phantom 1 and 3 is approximately 200%. FIG. 5B shows the same dataset as FIG. 5A but corrected according to the quantification method Q₁. It can be seen that there is a decreased deviation between the response curves. The deviation between the response curves has decreased in FIG. 5B compared to FIG. 5A as the three separate curves have collapsed to one universal response curve in FIG. 5B. At a PpIX concentration of 1.25 μg/mg, the maximum difference decreased 10-fold to approximately 20%. At lower PpIX concentrations a plateau was reached that was interpreted as the lower detection limit, as indicated by the dashed lines in FIG. 5A. This plateau was not due to camera noise, but by the autofluorescence of the phantom, as was confirmed by switching off the excitation light.

Clinical quantitative fluorescence imaging employing the quantification method Q₁ was investigated for patients with prostate cancer undergoing radical prostatectomy. Approval for this study was obtained from the research ethics board of the University Health Network and patients agreed to participation by signing a consent form. This study is ongoing and to date 6 patients have been enrolled, hence the results obtained here are preliminary in nature and serve the purpose only of demonstrating clinical feasibility. To induce PpIX, 20 mg/kg of 5-aminolevulinic acid (ALA) was administered orally in 50 ml of orange juice 5-6 hours prior to fluorescence imaging. The preliminary clinical results showed that the system is capable of detecting diffuse reflectance, autofluorescence, as well as marker fluorescence and can compute and display the corrected fluorescence images in real-time.

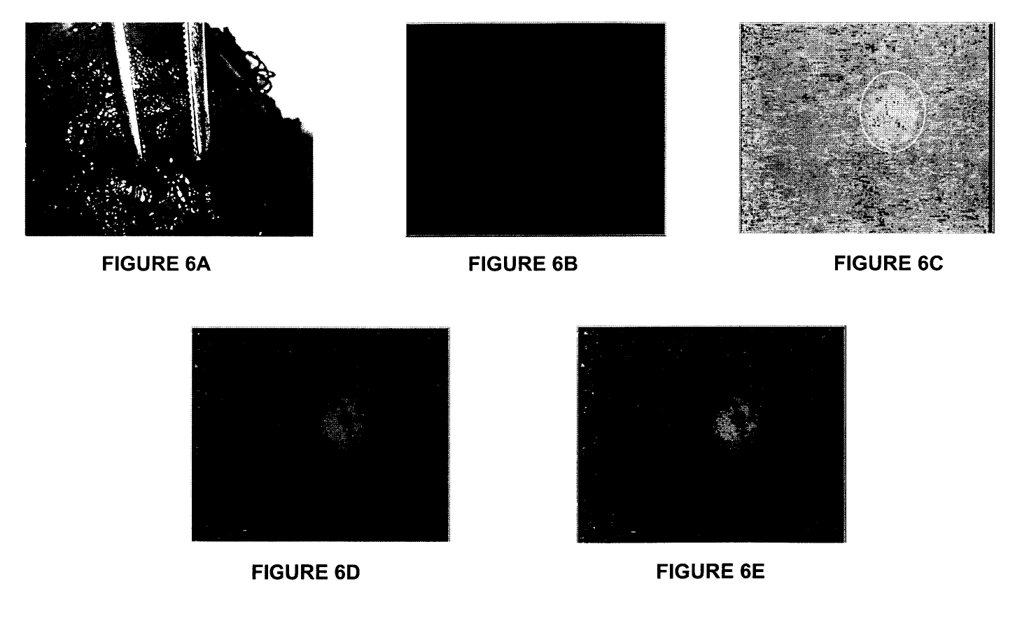

Intraoperatively, the capsule of the prostate showed a green autofluorescence with small amounts of diffusely reflected UV/blue excitation light. Various areas with red fluorescence were found on the prostate capsule and surgical bed. FIG. 6A shows a white light image of the prostate capsule with forceps around a nodule. FIG. 6b shows the unprocessed, raw fluorescence image showing small amounts of blue reflectance, green autofluorescence of the prostate capsule and bright red fluorescence of the nodule. FIG. 6C shows the same fluorescence image, which has now made quantitative through image processing according to method Q₁. As can be observed, most of the anatomical/structural information is lost. To alleviate this problem this image is thresholded (blue=0 intensity), as shown in FIG. 6D, and overlaid on the raw fluorescence image so that the resulting final image, shown in FIG. 6E, contains both structural/anatomical information as well as functional quantitative information. The clinical prototypical fluorescence imaging system was able to compute, display and store data computed according to the method Q₁ in real time (30 frames/sec) without dropping frames.

In another study, to further characterize the parameters and the performance of the clinical prototypical version of the fluorescence imaging system 200, a liquid phantom was prepared with methylene blue dye, fluorescein and intralipid solution. The absorption and reduced scattering coefficients were μₐ=1.9 cm⁻¹ and μₛ′=8 cm⁻¹ at 635 nm respectively. These optical properties were selected to be close to those found in the brain. System sensitivity was measured using different PpIX concentrations in the liquid phantom. For this, PpIX extract was added to the methylene blue-Intralipid phantom at 1.25, 0.62, 0.31, 0.15, 0.075 and 0.039 μg/mL. At each dilution, fluorescence images were taken at both of the dual excitation wavelengths, denoted here as excitation wavelength N, and excitation wavelength N+1. Images were taken at 1, 2, 3, 4, and 5 cm away from the phantom surface, with the camera focused at the 3 cm working distance.

The ratiometric method Q₃ was used based on two excitations and two emission wavelengths. The first excitation wavelength is in the absorption peak of PpIX (λ=405 nm) and the emitted red fluorescence is divided by diffusively reflected excitation light. Next, this first fluorescence/reflectance ratio is divided by a second fluorescence/reflectance ratio excited using a second excitation wavelength at a lower PpIX absorption peak (λ=440 nm). In this case, the target fluorescence Fₜₐᵣ originates from PpIX that is allowed to vary and the reference fluorescence Fᵣₑₜ originates from fluorescein and is assumed constant. Images of each phantom were taken, as well as an image of the phantom to provide a value for the background signal. The red channel of the 3-chip CCD was plotted as a function of base PpIX concentration.

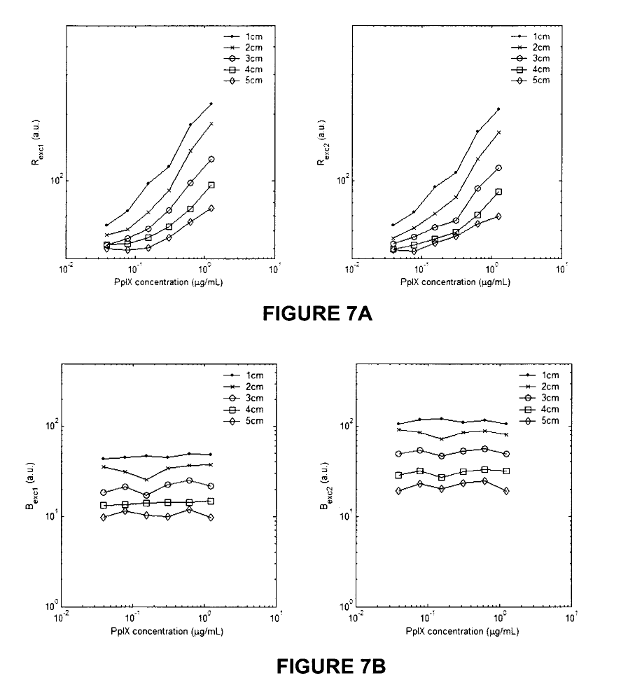

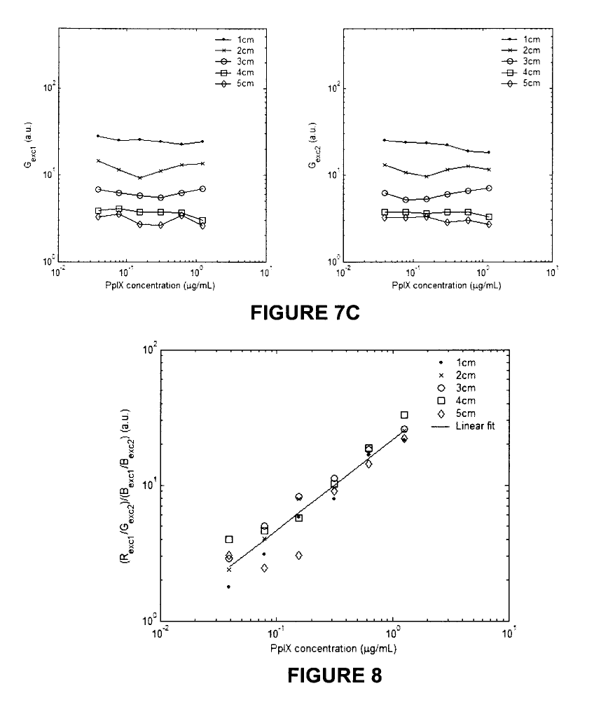

To perform quantitative analysis on the in vivo images, a rectangular region of interest (ROI) was drawn within the red fluorescing lesion for each image. The red, green, and blue components were averaged within each ROI. The resulting data set comprised of red, green, and blue components for each of three images taken at each of the three ALA dose levels. FIGS. 7A-7C show the PpIX fluorescence intensities, diffuse reflectance and green fluorescence for λ_{Exc1} and λ_{Exc2} in the tissue phantom. Differences in red fluorescence intensity in response to the differences in work distances and PpIX concentration are clearly observed.

Employing the fluorescence ratio imaging method Q₃ minimized the differences in response at different working distances, resulting in a universal curve which is linear to the PpIX concentration but is independent of the working distance, as shown in FIG. 8. This demonstrates the ability of this method to correct for variations in intensities and tissue properties and the sample geometry.

It should be noted that the quantification methods described herein can be modified so it can be used for NIR excitation and detection of phthalocyanine 4, and applied to novel dual-fluorescent markers. These markers can be conjugated to various targeting moieties, provide a linear response to marker concentration and further minimize the dependence on autofluorescence, as demonstrated through modeling.

It should also be noted that the various embodiments of the methods and system described herein may be further generalized to perform measurements, quantification and correction of luminescence signals originating from any luminescent particles from a region of interest of an object. For instance, a luminescence signal may be obtained instead of a target fluorescence signal in methods Q₁-Q₄, if the luminescence signal is known to vary with the parameter of interest in the region of interest. Alternatively, a luminescence signal may be obtained instead of a reference fluorescence signal in methods Q₃-Q₄, if the luminescence signal is known to remain constant in the region of interest. In another alternative, a luminescence signal may be obtained and used instead of a reflectance signal, if it is known that the luminescence signal depends similarly on optical properties as the target or reference signal; in this last case, the target or reference signal can be a fluorescence signal or more generally a luminescence signal.

It should be noted that the methods described herein can be used in the detection of diseases or progress of diseases, such as cancer, as well as in the assessment of treatments. For example, detection of fluorescence from a fluorophore coupled to a targeting molecule such as an antibody can be used to detect the presence of a target such as a tumor. The various methods described herein allow for improved detection of such markers. For example, fluorescence imaging of the marker PpIX can provide high resolution and high tissue-contrast images of tumour margins during intraoperative procedures, and the quantified signal may be used to aid the surgeon in determining at which point to stop or continue surgical resection.

The various methods described herein also provide for real-time imaging of tissues. Also, the fluorescence images generated using the methods described herein allow for the visualization of a region of interest comprising the fluorophore without interference from other signals such as contribution from oxygen, autofluorescence and the like that would be included in the raw (unprocessed) signal. Images obtained using the methods described herein can also be superimposed on each other or on raw fluorescence images to provide images with different types of information. Thus, for example, functional information provided by the fluorophore can be combined in this way with anatomical information provided in a raw fluorescence image.

The various embodiments of the methods and systems described herein can be used for the quantification of luminescence or fluorescence. The various embodiments of the methods and systems described herein can be used for at least one of imaging, spectroscopy and interferometry purposes for various uses such as medical diagnosis including cancer detection. In this regard, the various embodiments of the methods and systems described herein can be applied in the operation of microscopes, stereoscopes, endoscopes, bronchoscopes, cystoscopes, colposcopes, laparoscopes, robotic arms, capsules or other detection devices that can be inserted into the human body.

It will also be appreciated that the various embodiments of the methods and systems described herein can be used in combination with at least one of Magnetic Resonance Imaging (MRI), Computed Tomography (CT) imaging or any other imaging technique as well as for surgical guidance followed by at least one of photodynamic therapy, chemotherapy, radiotherapy, or any other type of adjuvant therapies. The various embodiments of the methods and systems described herein can also be used in at least one of locating a specific site for PhotoDynamic Therapy (PDT), monitoring PDT, performing PDT dosimetry and monitoring PDT response.

It should also be noted that the various embodiments of the methods and systems described herein can be used in various in vivo applications such as applications previously mentioned herein as well as real-time image guided surgery for many types of surgery such as brain tumor surgery, prostate cancer surgery, breast cancer surgery and other types of surgery. Other in vivo applications include functional tissue imaging, measurement of gene and protein expression, quantification of genes and proteins, small/large animal imaging, pH measurement, measurement of fluorophore quenching and un-quenching, measurement of in vivo singlet oxygen concentration and measurement of (fluorescent) photosensitizer concentration in Photodynamic therapy.

It should also be noted that the various embodiments of the methods and systems described herein can be used in various ex vivo applications such as ex vivo measurement of fluorophores, ex vivo quantification of fluorophores, quantification of fluorescence in tissue samples, biopsies, fresh cut tissues, and fixed tissues including tissue arrays and micro tissue arrays. Other ex vivo applications include any microscopy application including confocal microscopes, which use a pinhole to achieve optical sectioning to provide a quantitative, 3D view of the sample. Other applications include applications in biochemistry such as immunofluorescence and immunohistochemistry in tissue arrays and micro tissue arrays.

It should also be noted that the various embodiments of the methods and systems described herein can be used in cytomics such as in flow cytometry and fluorescence-activated cell-sorting. Other applications include any application in DNA large-scale sequencing strategies, any application in quantification of genes an proteins, any application to measure gene and protein expression, applications in DNA sequencing, applications in mRNA or gene expression profiling, applications in DNA micro arrays, applications in Dye-terminator sequencing, and any application in Polymerase Chain Reaction (PCR).

It should be understood that various modifications can be made to the embodiments described and illustrated herein, without departing from the embodiments, the general scope of which is defined in the appended claims.

1. A method for quantification of fluorescence from fluorophores in a region of interest of an object, wherein the method comprises:
selecting at least one type of fluorophore from the region of interest;
providing at least one excitation signal to the region of interest to produce fluorescence from the at least one type of fluorophore and to generate at least one reflectance signal;
obtaining the produced fluorescence and reflectance signals from the region of interest;
producing a quantified fluorescence signal for each of the resulting fluorescence signals by dividing by the corresponding reflectance signals; and
calculating at least one ratio of the quantified fluorescence signals.

2. The method of claim 1, wherein the method comprises obtaining the reflectance signals at an excitation wavelength used in the providing step.

3. The method of claim 2, wherein the introducing step comprises using a single type of fluorophore, the providing step comprises providing light energy at first and second excitation wavelengths respectively to the region of interest, and the obtaining step comprises obtaining first and second fluorescence signals at an emission wavelength of the single type of fluorophore due to excitation at the first and second excitation wavelengths respectively.

4. The method of claim 3, wherein the method comprises selecting the excitation wavelengths based on a relative absorption maximum and a relative absorption minimum of the at least one type of fluorophore such that there is a difference in the absorption between the excitation wavelengths.

5. The method of claim 2, wherein the selecting step comprises using two types of fluorophores comprising target and reference fluorophores in which the target fluorophores either vary in concentration throughout the region of interest or the target fluorophores have a substantially uniform concentration throughout the region of interest and produce variable fluorescence due to quenching or unquenching, and in which the reference fluorophores have a substantially uniform concentration throughout the region of interest.

6. The method of claim 5, wherein the providing step comprises providing light energy at first and second excitation wavelengths respectively to the region of interest, the obtaining step comprises obtaining a first fluorescence signal at a first emission wavelength of the target fluorophores due to excitation at the first excitation wavelength and obtaining a second fluorescence signal at a second emission wavelength of the reference fluorophores due to excitation at the second excitation wavelength:

7. The method of claim 1, wherein the step of calculating the quantified fluorescence signals comprises dividing the first fluorescence signal by the reflectance signal obtained at the first excitation wavelength and dividing the second fluorescence signal by the reflectance signal obtained at the second excitation wavelength.

8. The method of claim 6, wherein the method also comprises obtaining target and reference control measurements at the first and second emission wavelengths after excitation at both the first and second excitation wavelengths from the region of interest prior to introduction of the target and reference fluorophores respectively or in an area of the region of interest having negligible uptake of the target and reference fluorophores respectively.

9. The method of claim 8, wherein obtaining the target control measurement comprises dividing fluorescence at the first emission wavelength due to excitation at the first excitation wavelength by fluorescence at the first emission wavelength due to excitation at the second excitation wavelength and obtaining the reference control measurement comprises dividing fluorescence at the second emission wavelength due to excitation at the second excitation wavelength by fluorescence at the second emission wavelength due to excitation at the first excitation wavelength.

10. The method of claim 8, wherein the obtaining step also comprises obtaining a third fluorescence signal at the first emission wavelength of the target fluorophores due to excitation at the second excitation wavelength and obtaining a fourth fluorescence signal at the second emission wavelength of the reference fluorophores due to excitation at the first excitation wavelength, and the step of calculating the quantified fluorescence signal for the target fluorophores comprises subtracting the third fluorescence signal multiplied by the target control measurement from the first fluorescence signal and dividing by the reflectance signal obtained at the first excitation wavelength and the step of calculating the quantified fluorescence signal for the reference fluorophores comprises subtracting the fourth fluorescence signal multiplied by the reference control measurement from the second fluorescence signal and dividing by the reflectance signal obtained at the second excitation wavelength.

11. The method of claim 2, wherein the introducing step comprises using at least two types of target fluorophores and at least one type of reference fluorophores in which the target fluorophores either vary in concentration throughout the region of interest or the target fluorophores have a substantially uniform concentration throughout the region of interest and produce variable fluorescence due to quenching or unquenching, and in which the at least one type of reference fluorophores have a substantially uniform concentration throughout the region of interest.

12. The method of claim 11, wherein the providing step comprises providing signals with at least two target excitation wavelengths and at least one reference excitation wavelength respectively to the region of interest, the obtaining step comprises obtaining at least two target fluorescence signals from two or more emission wavelengths of the at least two types of target fluorophores due to excitation at the at least two target excitation wavelengths and obtaining at least one reference fluorescence signal from at least one reference emission wavelength of the at least one reference fluorophores due to excitation at the at least one reference excitation wavelength.

13. The method of claim 12, wherein the step of calculating the quantified fluorescence signals comprises dividing the at least two target fluorescence signals by corresponding reflectance signals obtained at the at least two excitation wavelengths and dividing the at least one reference fluorescence signal by a corresponding at least one reflectance signal obtained at the at least one reference excitation wavelength.

14. The method of claim 6, wherein the excitation wavelengths are different and the emission wavelengths are different.

15. The method of claim 6, wherein the excitation wavelengths are different and the emission wavelengths are the same.

16. The method of claim 6, wherein the excitation wavelengths are the same and the emission wavelengths are different.

17. The method of claim 1, wherein the selecting step comprises placing an article with at least one of known luminescence, known fluorescence, and known reflectance properties in the region of interest to provide a reference by which other obtained fluorescence and reflectance signals are compared.

18. The method of claim 1, wherein the method further comprises generating an image of at least a portion of the region of interest based on one of the at least one ratios.

19. The method of claim 18, wherein the method further comprises obtaining at least one additional image comprising anatomical information for at least a portion of the region of interest and generating a final image by superimposing the at least one additional image with the image.

20. The method of claim 1, wherein the selecting step comprises introducing the at least one type of fluorophore to the region of interest.

21. A fluorescence imaging system for acquisition and quantification of fluorescence from a region of interest of an object, wherein the system comprises:
a light source unit configured to produce at least one excitation signal that is provided to the region of interest to enable at least one fluorescence signal to be produced from at least one type of fluorophore in the region of interest and at least one reflectance signal to be produced from the region of interest;
a detection unit configured to obtain the fluorescence and reflectance signals produced from the region of interest; and
a data processing unit configured to calculate a quantified fluorescence signal for each of the produced fluorescence signals by dividing by the corresponding reflectance signals, and calculate at least one ratio of the quantified fluorescence signals.

22. The system of claim 21, wherein the detection unit is configured to obtain the reflectance signals at an excitation wavelength used in the at least one excitation signal.

23. The system of claim 22, wherein a single type of fluorophore is used, the light source unit is configured to provide energy at first and second excitation wavelengths and the detection unit is configured to obtain first and second fluorescence signals at an emission wavelength of the single type of fluorophore due to excitation at the first and second excitation wavelengths respectively.

24. The system of claim 23, wherein the excitation wavelengths correspond with a relative absorption maximum and a relative absorption minimum of the fluorophore, such that there is a difference in the absorption between the excitation wavelengths.

25. The system of claim of claim 22, wherein two types of fluorophores are used comprising target and reference fluorophores in which the target fluorophores either vary in concentration throughout the region of interest or the target fluorophores have a substantially uniform concentration throughout the region of interest and produce variable fluorescence due to quenching or unquenching, and in which the reference fluorophores have a substantially uniform concentration throughout the region of interest.

26. The system of claim 25, wherein the light source unit is configured to provide energy at first and second excitation wavelengths, the detection unit is configured to obtain a first fluorescence signal at a first emission wavelength of the target fluorophores due to excitation at the first excitation wavelength and obtain a second fluorescence signal at a second emission wavelength of the reference fluorophores due to excitation at the second excitation wavelength.

27. The system of claim 23, wherein the data processing unit is configured to calculate the quantified fluorescence signals by dividing the first fluorescence signal by the reflectance signal obtained at the first excitation wavelength and dividing the second fluorescence signal by the reflectance signal obtained at the second excitation wavelength.

28. The system of claim 26, wherein the detection and data processing units are configured to obtain target and reference control measurements at the first and second emission wavelengths after excitation at both the first and second excitation wavelengths at the region of interest prior to introduction of the target and reference fluorophores respectively or in an area of the region of interest having negligible uptake of the target and reference fluorophores respectively.

29. The system of claim 28, wherein obtaining the target control measurement comprises dividing fluorescence at the first emission wavelength due to excitation at the first excitation wavelength by fluorescence at the first emission wavelength due to excitation at the second excitation wavelength and obtaining the reference control measurement comprises dividing fluorescence at the second emission wavelength due to excitation at the second excitation wavelength by fluorescence at the second emission wavelength due to excitation at the first excitation wavelength.

30. The system of claim 28, wherein the detection unit is configured to obtain a third fluorescence signal at the first emission wavelength of the target fluorophores due to excitation at the second excitation wavelength and obtain a fourth fluorescence signal at the second emission wavelength of the reference fluorophores due to excitation at the first excitation wavelength, and the data processing unit is configured to calculate the quantified fluorescence signal for the target fluorophores by subtracting the third fluorescence signal multiplied by the target control measurement from the first fluorescence signal and by dividing by the reflectance signal obtained at the first excitation wavelength and to calculate the quantified fluorescence signal for the reference fluorophores by subtracting the fourth fluorescence signal multiplied by the reference control measurement from the second fluorescence signal and dividing by the reflectance signal obtained at the second excitation wavelength.

31. The system of claim 22, wherein at least two types of target fluorophores and at least one type of reference fluorophores are used in which the target fluorophores either vary in concentration throughout the region of interest or the target fluorophores have a substantially uniform concentration throughout the region of interest and produce variable fluorescence due to quenching or unquenching, and in which the at least one type of reference fluorophores have a substantially uniform concentration throughout the region of interest.

32. The system of claim 31, wherein the light source unit is configured to provide signals with at least two target excitation wavelengths and at least one reference excitation wavelength respectively to the region of interest, the detection unit is configured to obtain at least two target fluorescence signals from two or more emission wavelengths of the at least two types of target fluorophores due to excitation from the at least two target excitation wavelengths and obtain at least one reference fluorescence signal from at least one reference emission wavelength of the at least one reference fluorophores due to excitation at the at least one reference excitation wavelength.

33. The system of claim 32, wherein the data processing unit is configured to calculate the quantified fluorescence signals by dividing the at least two target fluorescence signals by corresponding reflectance signals obtained at the at least two excitation wavelengths and dividing the at least one reference fluorescence signal by a corresponding at least one reflectance signal obtained at the at least one reference excitation wavelength.

34. The system of claim 21, wherein the system is further configured to generate an image of at least a portion of the region of interest based on one of the at least one ratios.

35. The system of claim 34, wherein the system is further configured to obtain at least one additional image comprising anatomical information of the at least a portion of the region of interest and the data processing unit is configured to superimpose the at least one additional image with the image.

36. The system of claim 21, wherein the system further comprises a synchronization unit configured to provide timing signals to coordinate the activity of the light source, detection and data processing units.

37. The system of claim 21, wherein the system further comprises a delivery module configured to transmit light signals to the region of interest and a receiving module configured to transmit the resulting fluorescence and reflectance signals to the detection unit.

38. A method for quantification of fluorescence from fluorophores in a region of interest of an object, wherein the method comprises:
selecting a single type of fluorophore from the region of interest;
providing light energy at first and second excitation wavelengths to the region of interest corresponding to relative absorption maxima and minima of the fluorophore to produce first and second fluorescence signals at a similar emission wavelength from the fluorophore or providing light energy at an excitation wavelength to the region of interest to produce first and second fluorescence signals at a relative maxima and minima of the emission spectra of the fluorophore;
obtaining the first and second fluorescence signals from the region of interest;
calculating a ratio of the first and second fluorescence signals; and
generating a final image of at least a portion of the region of interest based on the ratio.

39. A method for quantification of luminescence originating from luminescent particles from a region of interest of an object, wherein the method comprises:
obtaining at least one first type of signal from the region of interest;
obtaining at least one second type of signal from the region of interest;
calculating a quantified signal for the at least one first type of signal by dividing by the corresponding second type of signal;
calculating at least one ratio of the quantified signals; and
generating a final image of at least a portion of the region of interest based on one of the at least one ratios,
wherein, the first type of signal comprises luminescence and the second type of signal comprises one of reflectance and luminescence that depends similarly on optical properties as the first type of signal.

40. The method of claim 1, wherein the object is a human, a tissue sample, a biopsy, fresh cut tissue, tissue arrays or micro tissue arrays.

41. The method of claim 1 for the detection of cancer.

42. The system of claim 21, wherein the object is a human, a tissue sample, a biopsy, fresh cut tissue, tissue arrays or micro tissue arrays.

43. The system of claim 21 for the detection of cancer.
